(19) United States
(12) Patent Application Publication
(10) Pub. No.: US 2004/0186880 A1
(43) Pub. Date: Sep. 23, 2004

(54) Management apparatus, terminal apparatus, and management system

(76) Inventors: Yoshiki Yamamoto, Hirakata-shi (JP); Takehide Fujimoto, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/685,402

(22) Filed: Oct. 16, 2003

(30) Foreign Application Priority Data
Oct. 17, 2002 (JP) 2002-302937

(51) Int. Cl. G06F 15/16

(52) U.S. Cl. 709/200

(57) ABSTRACT

A management system of the present invention is composed of: a requester terminal (110) for issuing a request signal for data processing to the management apparatus (100) so as to acquire file information from another terminal apparatus; a request reception terminal (120) for holding the file information; and a management apparatus (100) for managing the file information to be exchanged between the requester terminal (110) and the request reception terminal (120), all of which being mutually connected via a network bus (130).

### BACKGROUND OF THE INVENTION

(1) Field of the Invention

The present invention relates to a management apparatus that manages data processing performed between terminal apparatuses on a network formed of the terminal apparatuses, such as personal computers and information terminals, and also relates to a terminal apparatus.

(2) Description of the Related Art

In recent years, by way of a network that is formed by mutually connecting a plurality of terminal apparatuses, a system known as the “peer to peer” networking has been employed. With this system, chargeable contents files and information that requires the copyright protection are exchanged between terminal apparatuses such as personal computers or the like. For this exchange of data such as a contents file between the terminal apparatuses, a conventional system, where a server apparatus uniquely stores, manages, and then sends data to a requester terminal apparatus, is not employed. The data is exchanged between a terminal apparatus serving as a contents holder or the like and a requester terminal apparatus that requests for the processing. Therefore, when the chargeable information delivery service is executed between the terminal apparatuses, it becomes important that only the information approved by the contents holder or copyright holder is delivered.

A method has been provided, by which a management apparatus is set in the system via a network bus to manage the validity of the data exchange performed between the terminal apparatuses. FIG. 20 shows the overall configuration of conventional data management performed among a management apparatus 2001 and terminals via a network bus.

In FIG. 20, a requester terminal 2003 notifies the management apparatus 2001 that a desired contents file is “music. mp3”, for example. The management apparatus 2001 then refers to a list of request reception terminals including a request reception terminal 2002 and conducts a search for the request reception terminal 2002 that has the requested file “music. mp3”. Then, the management apparatus 2001 sends the search result to the requester terminal 2003 that requests for the delivery, via the network. Accordingly, the requester terminal 2003 can begin the data exchange with the request reception terminal 2002 that has the file “music. mp3”.

There is also a method called digital watermarking as an example to verify and deliver only the valid information from a terminal to another without using a server apparatus. With this digital watermarking, information denoting the validity of data in question can be embedded as a watermark without giving any influence on the data itself.

Also, there is another method by which a terminal apparatus checks the type of registered information and information of a non-defined type is rejected for registry (see Japanese Laid-Open Patent Application No. 07-105290, for example). This patent document 1 discloses that when data of a type different from the set document data type is inputted, the data is rejected for registry and that an input of false document data is accordingly prevented with accuracy.

Moreover, for the exchange of contents files, it is now common practice to employ a system where an apparatus called an authentication server is provided on a network to uniquely manage contents files and judge for each user terminal whether the terminal is to be authorized to receive information, and then the server apparatus sends the contents file which the terminal requested for.

However, by means of the above-mentioned method for managing the data exchange between the terminals using the management apparatus shown in FIG. 20, the management apparatus only locates which terminal is to be the delivery source, meaning that the substantial file exchange is performed directly between the terminals. For this reason, there may be a risk that file information causing an infringement of a copyright is exchanged between the terminals or that an unauthorized virus file is sent to the terminal apparatus serving as the delivery source. Also, even if data exchange is freely performed between the terminals via the network, the management apparatus is incapable of conducting the management such as prevention of unauthorized performances.

Meanwhile, if employing the digital watermarking method as stated above, the terminal will be under heavy load for verifying the “watermark,” resulting in a decrease in the processing speed.

Moreover, by means of the method disclosed in the patent document 1, the terminal apparatus itself verifies the validity of the inputted data, ending up processing even unauthorized data.

Furthermore, in the stated case where the authentication server is used for managing the data exchange between the terminals, the authentication server uniquely manages data and performs all the processes including authentication and necessary delivery, so that processing load given to the authentication server is increased due to concentrated accesses to the server. Also, a problem has arisen that once a delivery source terminal is authorized, the authentication server does not have a way of knowing exactly what kind of data is delivered, when a members-only network is employed for chargeable contents delivery, for example.

It is an object of the present invention to solve the stated conventional problems. Also, it is an object to provide a management apparatus and terminal apparatuses for a case where data to be processed between the terminal apparatuses is managed using the management apparatus, wherein the management apparatus manages data processing executed between the terminal apparatuses without increasing processing load of these terminal apparatuses and itself, and wherein unauthorized data processing is prevented from being performed between the terminal apparatuses so that the data delivery can be executed with ensured safety.

### SUMMARY OF THE INVENTION

To solve the stated problems, a management apparatus of the present invention is provided with: a reception unit operable to receive a request signal from one of the terminal apparatuses that requests for the data processing; and a verification unit operable to verify validity of data relevant to the data processing when receiving the request signal. The verification unit verifies the validity of the data using at least a part of information of the data. The management apparatus is further provided with: an issuing unit operable to issue a granting signal to the terminal apparatus when the validity of the data is verified by the verification unit, and issue a denying signal to one of the terminal apparatus that performs the data processing and another terminal apparatus that is requested to perform the data processing or both the terminal apparatus and the other terminal apparatus when the validity of the data is not verified by the verification unit; and a transmission unit operable to transmit one of the granting and denying signals to the terminal apparatus. More preferably, the management apparatus is further provided with: a download unit operable to download the data, which is to be processed between the terminal apparatuses, from the terminal apparatus; an extraction unit operable to extract at least a part of information for each set of the downloaded data; a storage unit operable to store the information extracted by the extraction unit; and a response requesting unit operable to send a response request to a request reception terminal, which is requested to perform the data processing, for a response with information relevant to first information stored in the storage unit, wherein the verification unit verifies the validity of the data by comparing the first information to second information sent from the request reception terminal apparatus responding to the response request.

With this construction, after receiving the authorization request signal from the terminal that starts the processing, the management apparatus verifies the validity of data to be delivered between the terminals using the verification unit and, if the verification is positive, sends a granting signal to the requester terminal. Thus, the management apparatus can manage the data delivery executed between the terminals, according to the granting signal.

Also, because the verification unit performs the verification processing using a part of the processing object data, the management apparatus does not need to store or manage the whole of data, thereby reducing the load of the verification processing. The terminal apparatus of the present invention is provided with: a reception unit operable to receive a request for the data processing; a second issuing unit operable to issue a request signal requesting for the data processing; and a second transmission unit operable to transmit the request signal to the management apparatus. The terminal apparatus is further provided with: a second storage unit operable to store data relevant to the data processing; a readout unit operable to read out, when a response request for a response with information regarding at least a part of the data is received from the management apparatus, relevant information relevant to the response request from the second storage unit; and a response unit operable to respond to the management apparatus with the relevant information read out by the readout unit. More preferably, the terminal apparatus is further provided with: a second reception unit operable to receive one of granting and denying signals from the management apparatus, the signals respectively indicating that the data processing to be performed with the other terminal apparatus is authorized and unauthorized; a judgment unit operable to judge that the data processing performed with a request reception apparatus, that is requested to perform the data processing, is to be started when the granting signal is received, and judge that the data processing performed with the request reception terminal is not to be performed when the denying signal is received; and a data processing unit operable to perform the data processing with the other terminal apparatus in accordance with details authorized by the management apparatus when the granting signal is received.

With this construction, the terminal apparatus of the present invention generates a process authorization request signal and sends it to the management apparatus when wishing to perform the data processing with another terminal apparatus. When receiving the response request for the relevant information from the management apparatus, the terminal apparatus generates the relevant information and responds with it to the management apparatus. Moreover, the terminal apparatus can begin the processing with the other terminal apparatus only when receiving the granting information from the management apparatus. Accordingly, unauthorized data processing is prevented, and the data exchange can be performed with safety ensured by the management apparatus.

It should be understood that the present invention can be realized not only by the above-stated management apparatus and the terminal apparatus. The present invention can be applied to: a management system where the management apparatus and the terminal apparatuses are connected via a network; a management method having steps corresponding to the units provided in the management apparatus; and to a program realizing the management method using a computer or the like. This program can be distributed via a record medium such as a DVD and CD-ROM, or via a transmission medium such as a communication network.

### BRIEF DESCRIPTION OF THE DRAWINGS

FIG. 1 is a block diagram showing an example construction of a management system employed for data processing performed between terminals in a first embodiment of the present invention.

FIG. 2 is a detailed functional block diagram of a management apparatus in the first embodiment.

FIG. 3 is a detailed functional block diagram of a requester terminal in the first embodiment.

FIG. 4 is a detailed functional block diagram of a request reception terminal in the first embodiment.

FIG. 5 is a sequence diagram illustrating a general data flow in the overall management system in the first embodiment.

FIGS. 6 (a)-(c) show constructions of data exchanged among the management apparatus, the requester terminal, and the request reception terminal of the management system in the first embodiment.

FIG. 7 is a flowchart showing an operational procedure executed between the instant when the management apparatus receives a delivery authorization request signal from the requester terminal and the instant when the management apparatus sends a delivery granting signal to the requester terminal in the first embodiment.

FIG. 8 is a flowchart showing an operational procedure executed between the instant when the requester terminal sends an authorization request signal to the management apparatus and the instant when the requester terminal issues a delivery request in the first embodiment.

FIG. 9 is a flowchart showing an operational procedure executed between the instant when the request reception terminal receives a data verification signal from the management apparatus and the instant when the request reception terminal delivers the file information to the requester terminal in the first embodiment.

FIG. 10 is a flowchart showing an operational procedure executed when a file generated by the request reception terminal that is a contents holder is uploaded to the management apparatus in the management system in the first embodiment.

FIG. 11 is a functional block diagram of the management apparatus that is provided with a relevant information extraction unit.

FIG. 12 is a functional block diagram of a processing terminal that is provided with both an authorization request signal issuing unit and a data verification unit.

FIG. 13 is a functional block diagram of a management system that is composed of a management apparatus, a requester terminal, and a request reception terminal in a second embodiment of the present invention.

FIG. 14 is a flowchart showing an operational procedure from the reception of an authorization request to the issue of granting information by the management apparatus in the second embodiment.

FIG. 15 a reference diagram of data stored in a data registration unit.

FIG. 16 is a block diagram showing the overall construction of a management system in a third embodiment.

FIG. 17 is a sequence diagram illustrating a general data flow in the management system in the third embodiment.

FIG. 18 shows an example data construction of a process authorization request signal sent from the requester terminal to the request reception terminal in the third embodiment.

FIG. 19 shows the overall construction of a management system employed for remote maintenance in a fourth embodiment.

FIG. 20 is a block diagram showing the overall configuration of conventional data management achieved among a management apparatus and terminals via a network bus.

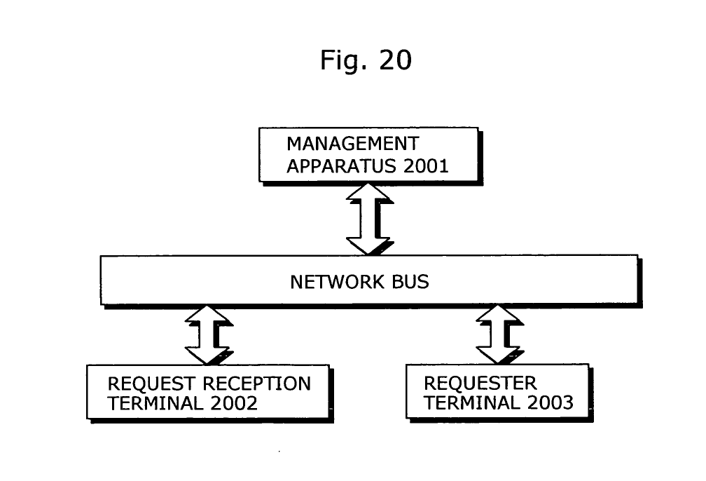

### DESCRIPTION OF THE PREFERRED EMBODIMENT

The following is a description of a management system of the present invention, with reference to the accompanying drawings. Note that the following explanation and the drawings are only examples, and the present invention is not limited to the embodiments below. Thus, although an explanation will be given for a case where contents of music and motion video files are delivered between the terminals in the embodiments below, processing performed between the terminals is not limited to the delivery and other performances such as movement and deletion of the file information are possible.

### First Embodiment

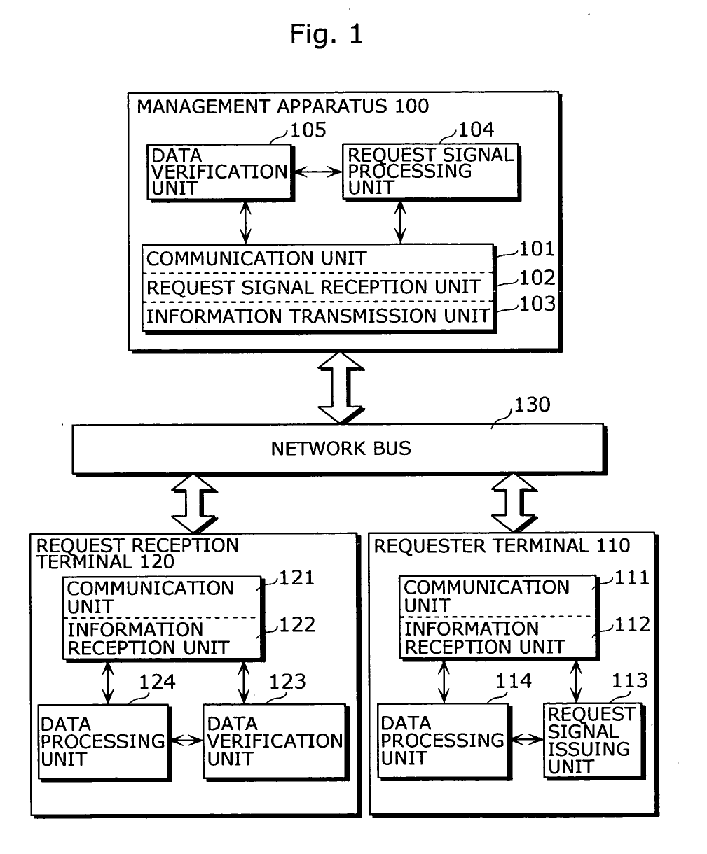

FIG. 1 is a block diagram showing an example construction of a management system employed for data processing executed between terminals in the first embodiment of the present invention. This management system of the first embodiment is composed of a requester terminal 110, a request reception terminal 120, and a management apparatus 100 that manages file information that is to be delivered between the requester terminal 110 and the request reception terminal 120, and a network bus 130 by way of which these apparatus and terminals are mutually connected. The management apparatus for managing the file information that is to be delivered between the terminals is composed of: a communication unit 101 for communicating with the requester terminal 110 and the request reception terminal 120 via the network; a request signal reception unit 102 for receiving a process authorization request signal sent from the requester terminal 110; an information transmission unit 103 for transmitting a granting or denying signal to the requester terminal 110 and the request reception terminal 120 in accordance with the verification result given by a data verification unit 105; a request signal processing unit 104 for processing the process authorization request signal received by the request signal reception unit 102; and a data verification unit 105 for verifying the contents and validity of data that is to be processed between the terminals.

The requester terminal 110 that issues a request signal to the management apparatus 100 to acquire the file information from another terminal is composed of: a communication unit 111 for communicating with the request reception terminal 120 and the management apparatus 100; an information reception unit 112 for receiving granting or denying information issued from the management apparatus 100; a request signal issuing unit 113 for issuing a process authorization request signal to the management apparatus 100; and a data processing unit 114 for performing the data processing in accordance with the authorized details given by the management apparatus 100.

The request reception terminal 120 that holds file information is composed of: a communication unit 121 for communicating with the requester terminal 110 and the management apparatus 100; an information reception unit 122 for receiving granting or denying information issued from the management apparatus 100; a data verification unit 123 for processing a data verification signal sent from the management apparatus 100; and a data processing unit 124 for responding to a request from the management apparatus 100.

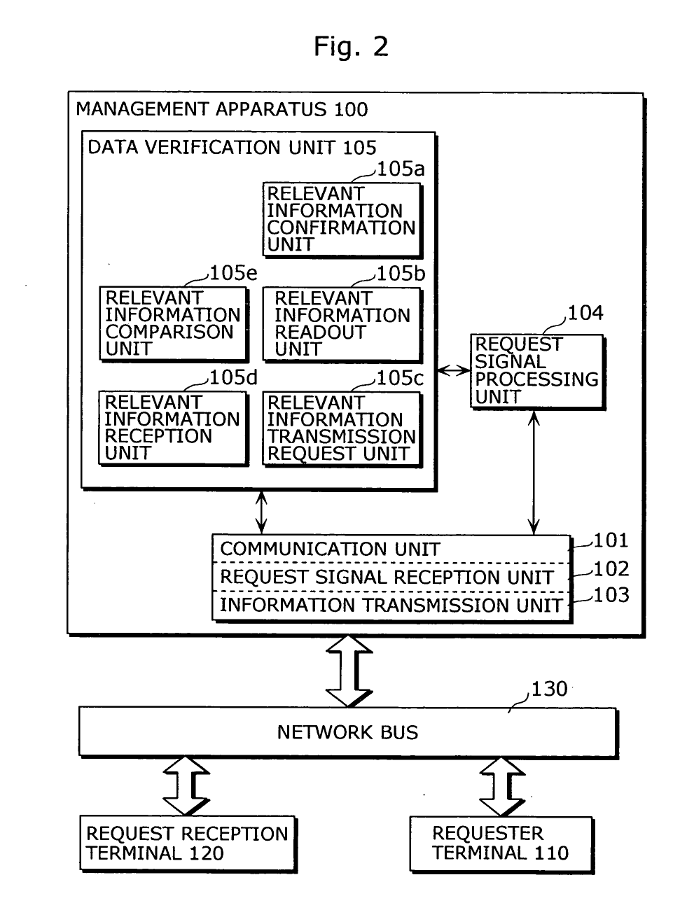

FIG. 2 is a detailed functional block diagram of the management apparatus 100 in the first embodiment.

The data verification unit 105 is composed of: a relevant information confirmation unit 105a for confirming contents of a process authorization request signal sent from the request signal processing unit 104; a relevant information readout unit 105b for reading out the information from a database of the management apparatus 100; a relevant information transmission request unit 105c for requesting the request reception terminal 120 that has the relevant information for a response of the relevant information; a relevant information reception unit 105d for receiving the response to the request from the request reception terminal 120; and a relevant information comparison unit 105e for comparing the relevant information held in the management apparatus 100 to the relevant information included in the response received from the request reception unit 120.

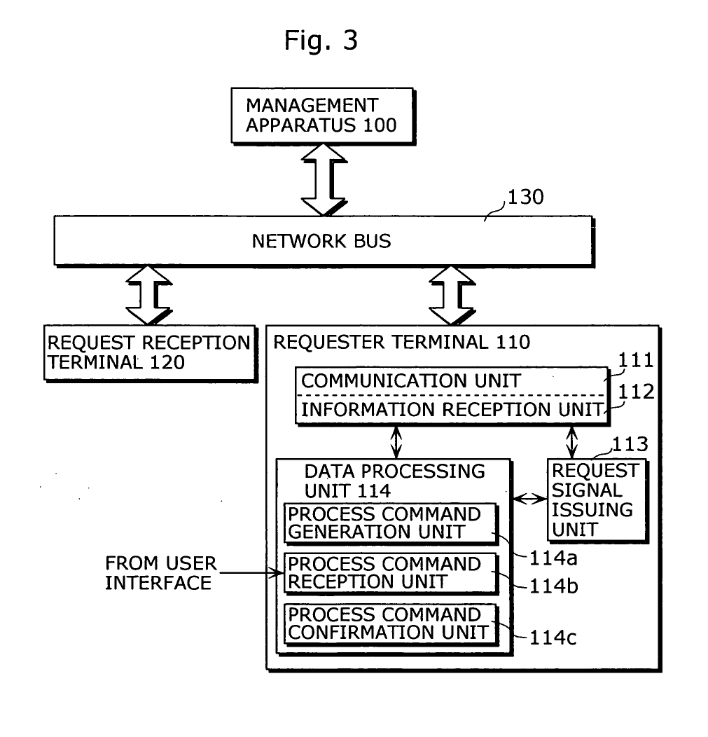

FIG. 3 is a detailed functional block diagram of the requester terminal 110 of the first embodiment.

The data processing unit 114 is composed of: a process command generation unit 114a for generating an appropriate process command for a process execution unit such as a CPU in accordance with details of the authorized information given by the management apparatus 100; a process command reception unit 114b for receiving a command related to processing that is inputted from a user interface such as a keyboard; and a process command confirmation unit 114c for confirming contents of the command inputted from the user interface. Here, the command received by the process command reception unit 114b is a request for the delivery of a specific motion video file, for example.

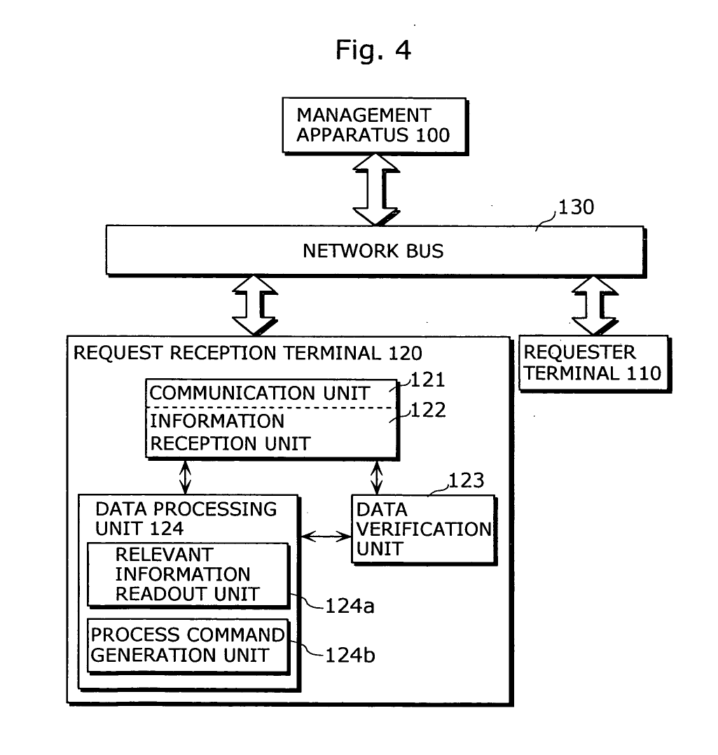

FIG. 4 is a detailed functional block diagram of the request reception terminal 120 in the first embodiment.

The data processing unit 124 is composed of: a relevant information readout unit 124a for reading out the relevant information from the file information that is a processing object in accordance with the request from the management apparatus 100; and a process command generation unit 124b for generating a process command according to the process authorization information sent from the management apparatus 100.

Upon the receipt of the processing data from the data verification unit 123, the relevant information readout unit 124a confirms the designated file or designated location and then reads out the data from a data storage unit such as memory.

When receiving a delivery granting signal from the information reception unit 122, the process command generation unit 124b instructs a process execution unit such as a CPU to set the process reception commencement state for the file delivery to the requester terminal 110. When the information reception unit 122 receives the denying signal, the process command generation unit 124b generates a command not to receive the processing from the requester terminal 110.

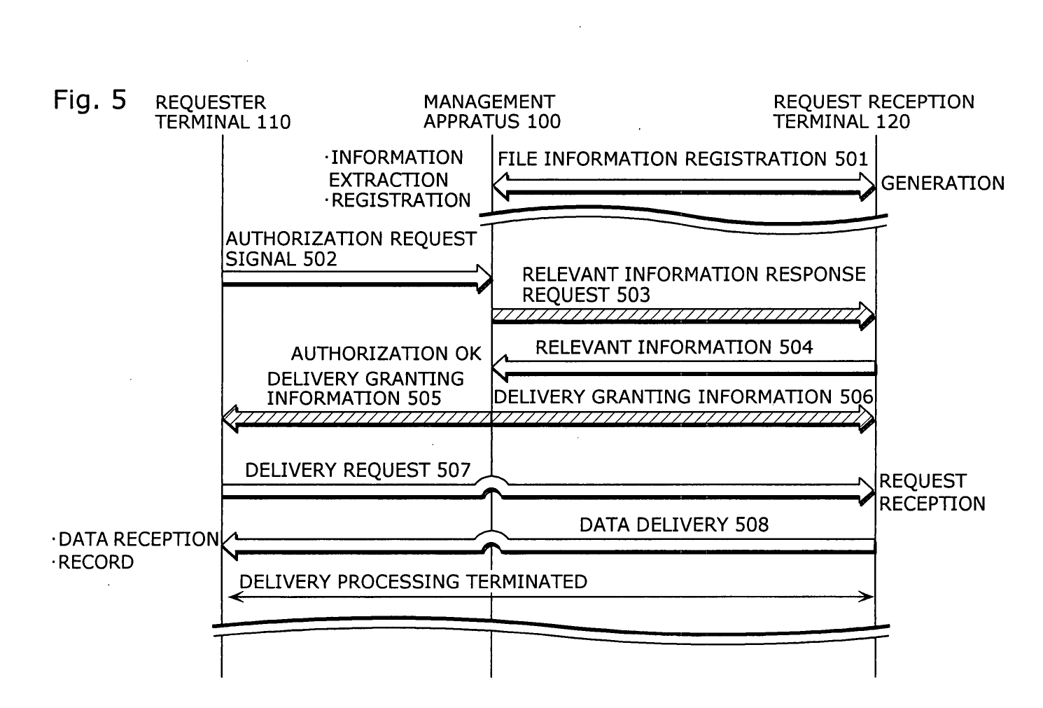

The following is an explanation of an operational procedure performed in the management system of the first embodiment as described above, with reference to FIGS. 5 to 9.

FIG. 5 is a sequence diagram illustrating a general data flow in the overall management system of the first embodiment. Note that the management apparatus 100 previously acquires file information that is to be delivered between the terminals through the downloading or the like and registers the file information into the database (501), so that the relevant information comparison unit 105e of the data verification unit 105 can perform the data comparison process later on. The management apparatus 100 of the first embodiment does not register the whole of file information that is to be delivered between the terminals, but as its characteristics, the management apparatus 100 extracts at least a part of the file information and registers the extracted part into the database.

First, the requester terminal 110 directs the request signal issuing unit 113 to issue a process authorization request signal to the management apparatus 100 when requiring file information from the request reception terminal 120 (502).

Next, receiving this process authorization request signal, the management apparatus 100 directs the relevant information transmission request unit 105c to send a response request for transmission of the relevant information to the request reception terminal 120 in order to verify the validity of the relevant file information that is to be delivered (503). The relevant information mentioned here is a value at the specific location or the like of the relevant information to be delivered.

When receiving the relevant information response request from the management apparatus 100 (503), the request reception terminal 120 directs the relevant information readout unit 124a to read out the relevant information from the file information, and then responds with the relevant information to the management apparatus 100 via the communication unit 121 (504).

This relevant information received by the relevant information reception unit 105d of the management apparatus 100 is sent to the relevant information comparison unit 105e which performs comparison processing to judge whether or not the file information possessed by the request reception unit 120 is valid.

If the relevant information registered in the management apparatus 100 is in agreement with the relevant information sent from the delivery source and the validity is verified, a delivery granting signal (505 and 506) is sent to both the requester terminal 110 and the request reception terminal 120 from the management apparatus 100.

Next, upon the receipt of the granting signal (505), the requester terminal 110 sends a delivery request directly to the request reception terminal 120 (507). The request reception terminal 120, receiving the delivery request (507), performs the data delivery of the requested file information to the requester terminal 110 (508) with reference to the processing described in the delivery granting signal (506). Accordingly, the sequential delivery processing is terminated here.

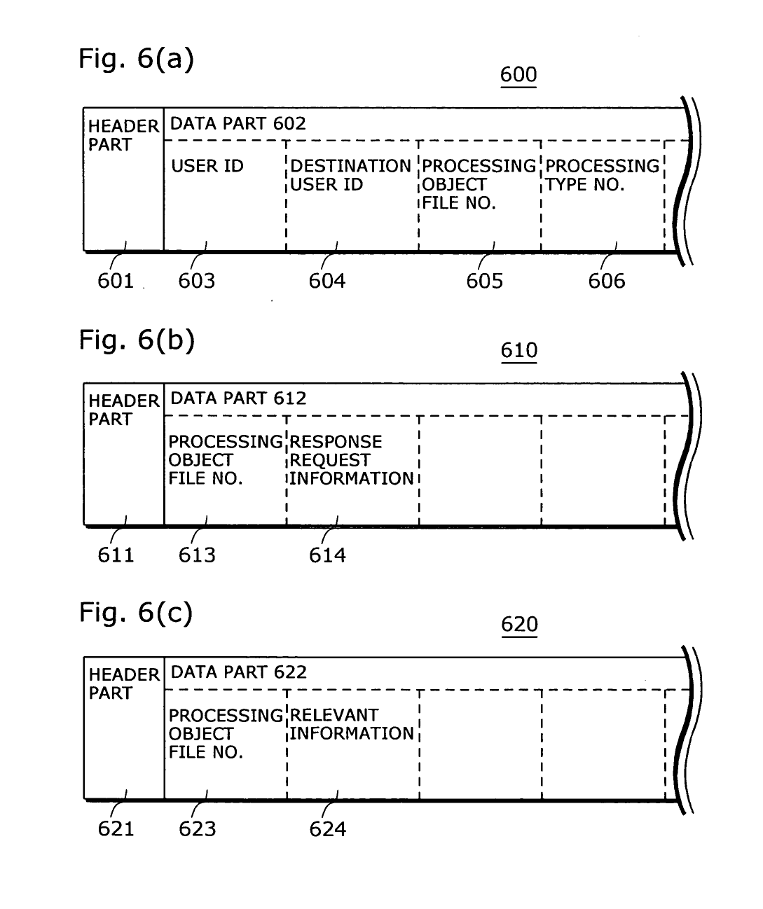

FIG. 6 shows constructions of data delivered among the management apparatus, the requester terminal 110, and the request reception terminal 120 of the management system in the first embodiment.

FIG. 6(a) is an example data construction of a process authorization request signal 600 generated by the request signal issuing unit 113 of the requester terminal 110 and sent to the management apparatus 100. The process authorization request signal 600 is made up of: a header part 601 including address information of a delivery destination and a delivery source; and a data part 602 including a user ID 603 of the requester terminal 110 that issues the process authorization request signal, a destination user ID 604 of the request reception terminal 120, a processing object file number 605 denoting a file name of the processing object, and a processing type number 606 denoting a type of the processing that the requester terminal 110 requests the management apparatus 100 to authorize. Here, the processing type described in the processing type number 606 is delivery, deletion, movement, or the like, for example.

FIG. 6(b) shows the data construction of a relevant information response request signal 610 that is generated by the relevant information transmission request unit 105c of the management apparatus 100 and sent to the request reception terminal 120. The relevant information response request signal 610 is made up of: a header part 611 including address information; and a data part 612 including a processing object file number 613 and response request information 614. The relevant information readout unit 124a of the request reception unit 120 reads out the relevant part of data from the file information that is to be delivered, according to the response request information 614, generates a response packet 620 including the relevant information, and sends it to the management apparatus 100.

FIG. 6(c) is an example data construction of the response packet 620 that is generated by the data processing unit 124 of the requester terminal 120 and sent to the management apparatus 110 as the relevant information response. The response packet 620 is made up of: a header part 621 including address information; and a data part 622 including a processing object file number 623 and relevant information 624.

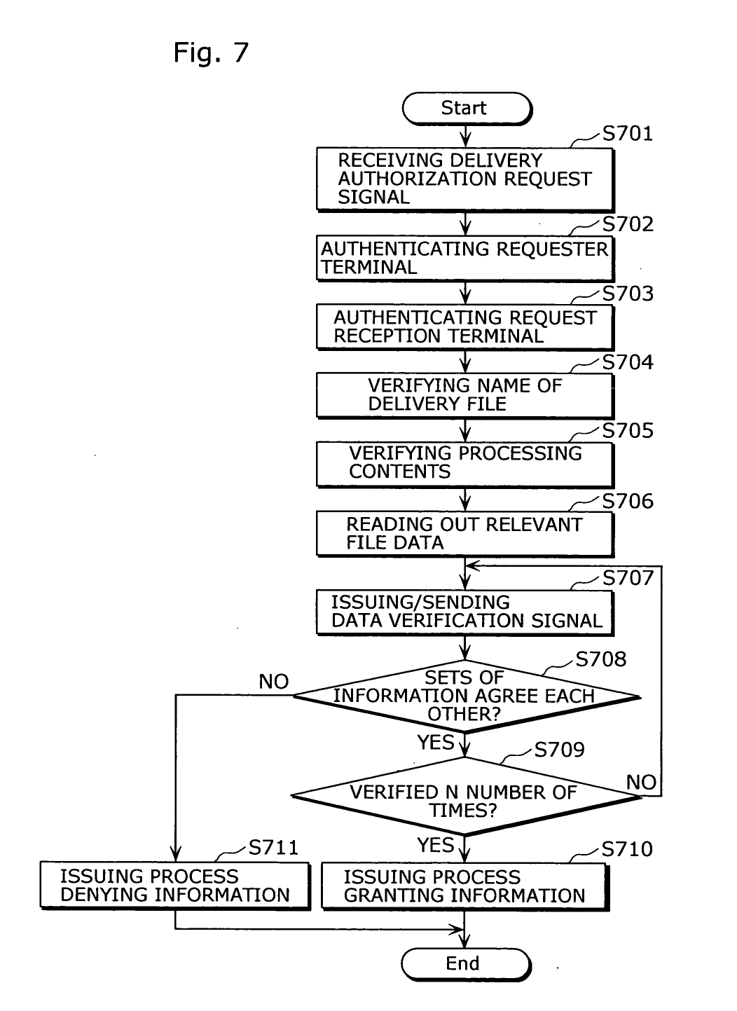

FIG. 7 is a flowchart showing an operational procedure executed between the instant when the management apparatus 100 receives the delivery authorization request signal from the requester terminal 110 and the instant when the management apparatus 100 sends a delivery granting signal to the requester terminal 110.

First, an explanation is given for the process authorization verification procedure performed by the management apparatus 100. When the request signal reception unit 102 of the management apparatus 100 receives the process authorization request signal from the requester terminal 110 via the communication unit 101 (S701), the request signal processing unit 104 authenticates the requester terminal 110 based on the user ID 603 included in the authorization request signal 600 (S702).

Also, the request signal processing unit 104 obtains the request reception terminal 120, which has the requested file information, from the destination ID 604 and authenticates it (S703). The request signal processing unit 104 further interprets the contents of the process authorization request signal by reading out the processing object file number 605 and the processing type number 606 (S704 and S705). Here, the processing type number 606 is “0” indicating “delivery,” for example. In the case of a file movement request, for example, “2” indicating “movement” is multiplexed into the processing type number 606. As another example, in a case where the requester terminal 110 requests for “deletion” of the file possessed by the request reception terminal 120, “1” indicating “deletion” is multiplexed.

Then, the request signal processing unit 104 reads out the relevant file data (S706) and, if judging that the file information delivery between the terminals 110 and 120 might be authorized, requests the data verification unit 105 to perform processing. The relevant information confirmation unit 105a of the data verification unit 105 confirms the contents of the process authorization request signal sent from the request signal processing unit 104.

Following this, the relevant information confirmation unit 105a confirms the relevant file as well as the request reception terminal 120 that has the relevant file, according to the process authorization request signal. The relevant information readout unit 105b then reads out the information relevant to the relevant file confirmed by the relevant information confirmation unit 105a, from the database.

Moreover, the relevant information transmission request unit 105c generates the relevant information response request signal 610 and sends it to the request reception terminal 120 in order to verify the validity of the relevant file possessed by the request reception terminal 120 (S707).

Next, the relevant information reception unit 105d performs processing to receive the relevant information response from the request reception terminal 120 (S708). When receiving the information, the relevant information reception unit 105d sends it to the relevant information comparison unit 105e. The relevant information comparison unit 105e compares the information sent from the request reception terminal 120 to the information read out by the relevant information readout unit 105b. If these sets of information are in agreement with each other and the received information is judged to be valid (YES in S708), the relevant information comparison unit 105e judges whether this comparison processing should be performed N number of times at several locations of data for the verification (S709). As an example method of the file information verification processing performed by the relevant information comparison unit 105e, the request reception terminal 120 is requested to send a value at a designated location of the file or a specific format part such as a header of the file, and based on the partial format information, the relevant information comparison unit 105e may check whether or not an encryption flag is set.

After completing the judgment processing N number of times (YES in S709), the relevant information comparison unit 105e sends granting information to the information transmission unit 103, with the granting information indicating that the data processing between the terminals is authorized. On the other hand, if judging that the information sent from the request reception terminal 120 is not valid (NO in S708), the relevant information comparison unit 105e sends process denying information to the information transmission unit 103, with the process denying information indicating that the data processing between the terminals is unauthorized.

The information transmission unit 103 sends the process granting or denying information sent from the request signal processing unit 104 or the data verification unit 105 to both the requester terminal 110 and the request reception terminal 120 via the communication unit 101 (S710 and S711). Note that although the process denying information is sent in S711 in FIG. 7, this step does not necessarily need to be performed and can be omitted.

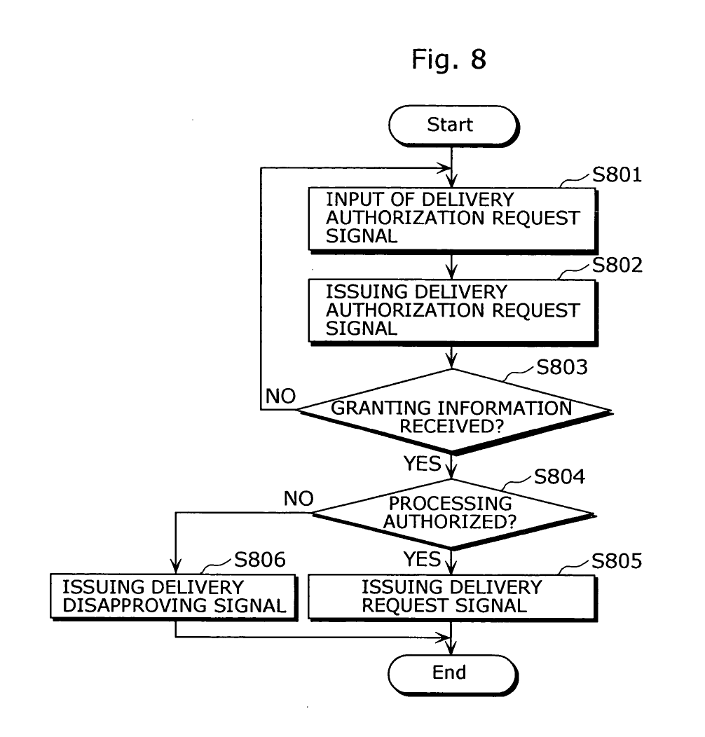

Next, an explanation is given for an operation performed by the requester terminal 110 that issues a process authorization request signal. FIG. 8 is a flowchart showing an operational procedure executed between the instant when the requester terminal 100 sends the authorization request signal to the management apparatus 100 and the instant when the requester terminal 110 issues a delivery request.

First, the process command reception unit 114b of the data processing unit 114 receives a request for file information as well as for processing details, with the request being inputted using the user interface such as a keyboard. Then, the requester terminal 110 directs the request signal issuing unit 113 to issue the authorization request signal (S801). Receiving the inputted information, the process command reception unit 114b sends it to the process command confirmation unit 114c.

Out of the received information, the process command confirmation unit 114c extracts a command that requires the authorization from the management apparatus 100, and sends the processing details t hat requires the authorization to the signal issuing unit 113.

The signal issuing unit 113 issues the process authorization request signal (S802) and sends it to the management apparatus 100 via the communication unit 111.

When the signal issuing unit 113 issues the process authorization request signal and sends it to the management apparatus 100, the information reception unit 112 performs reception processing to receive the granting or denying information that is to be sent from the management apparatus 100 (S803).

Then, the management apparatus 100 performs the verification processing to verify the data validity as stated above. If receiving the delivery granting information (YES in S803), the information reception unit 112 notifies the data processing unit 114 of it. On the other hand, if the delivery granting information is not received, the processing goes back to S801 so that the input process to send the delivery authorization request signal is performed again (NO in S803).

The process command generation unit 114a of the data processing unit 114 interprets the granting information sent from the information reception unit 112 (S804). In the case of the denying information (No in S804), the process command generation unit 114a issues a delivery disapproving signal (S806). When the authorization is granted (YES in S804), the command generation unit 114 generates a delivery request signal in accordance with the authorized details (S805) and sends it to the request reception terminal 120. Accordingly, this sequential procedure is terminated here.

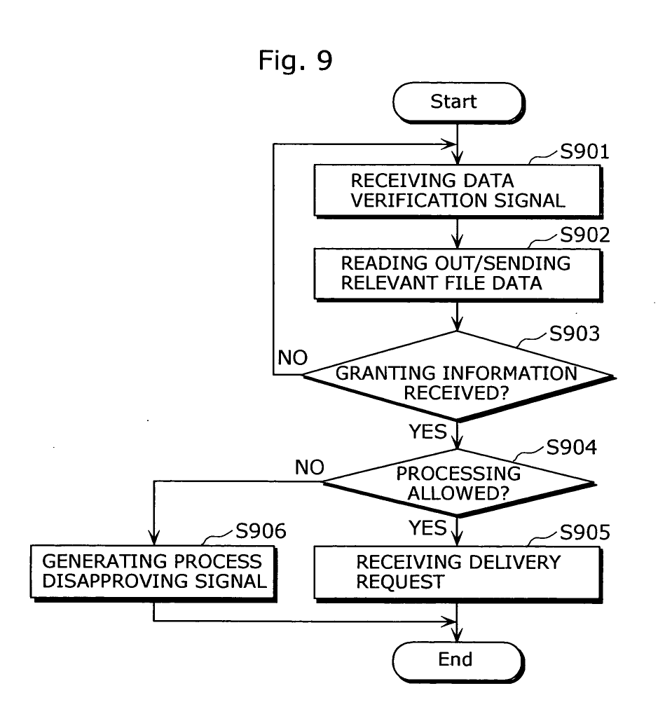

Next, an explanation is given for an operational procedure that is executed between the instant when the request reception terminal 120 of the first embodiment receives a data verification signal from the management apparatus 100 and the instant when the request reception terminal 120 delivers the file information to the requester terminal 110, with reference to a flowchart shown in FIG. 9.

First, upon the receipt of the data verification signal from the management apparatus 100 (S901), the relevant information readout unit 124a of the data processing unit 124 reads out a value at the designated location from the designated file information and generates the response packet 620 as the relevant information to send to the management apparatus 100 (S902).

Following this, the information reception unit 122 of the request reception terminal 120 performs reception processing to receive the delivery granting information from the management apparatus 100 (S903). If this reception processing is performed (YES in S903), the data verification unit 123 judges whether or not the requested file information is allowed to be delivered (S904). If the reception processing is not performed (NO in S903), the information reception unit 122 goes back to S901 again to perform the reception processing to receive the data verification signal.

If judging that the delivery is allowed (YES in S904), the data verification unit 123 starts receiving the delivery request from the requester terminal 110 (S905). If the delivery is not allowed (NO in S904), the data verification unit 123 generates a delivery disapproving signal, and does not accept a delivery request from the requester terminal 110 (S906). Accordingly, the sequential processing performed by the request reception terminal 120 is terminated here.

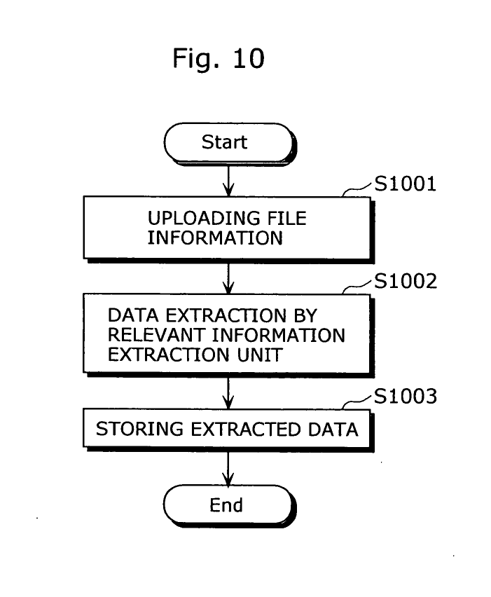

FIG. 10 is a flowchart showing an operational procedure executed when a file generated by the request reception terminal 120 that is a contents holder is uploaded to the management apparatus 100 in the management system of the first embodiment.

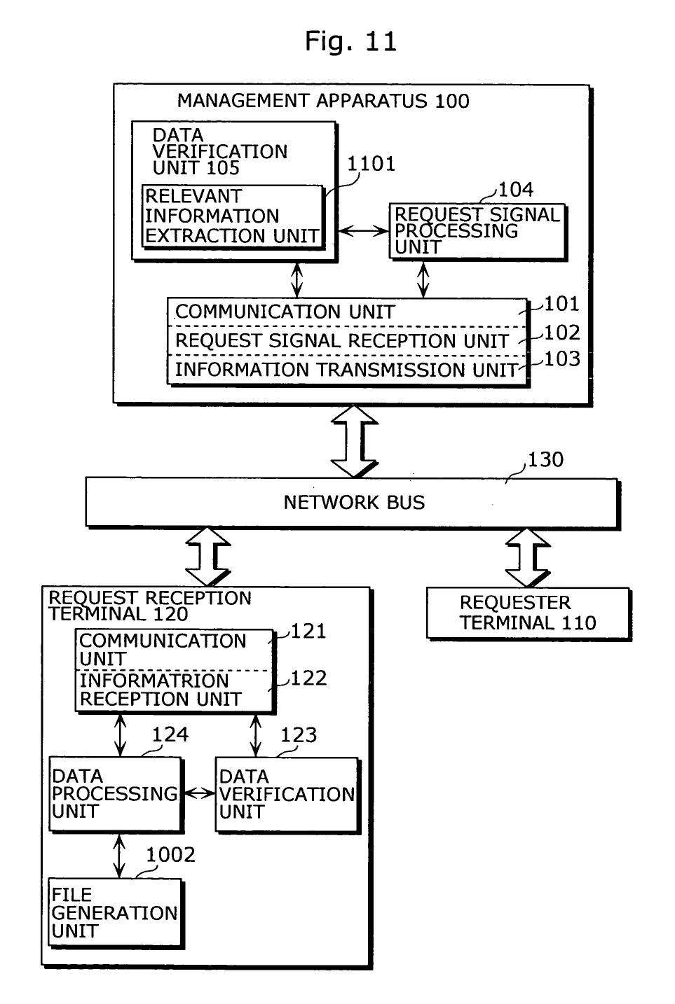

First, the request reception terminal 120, which generates or acquires contents, uploads the file information to the management apparatus 100 (S1001). This file information is a music or motion video file, for example, that is generated by a file generation unit 1002 provided in the request reception terminal 120 as shown in FIG. 11. The file information may be purchased from another terminal apparatus.

The data verification unit 105 of the management apparatus 100 verifies the contents of the received file information and extracts a part of the file information that is to be used for the management later on (S1002). The extracted information is then stored into the database (S1003). The method of extracting partial information is achieved by providing a relevant information extraction unit 1101 in the confirmation unit 105 of the management apparatus 100 as shown in FIG. 11, for example.

As explained so far, the management apparatus 100 of the first embodiment is composed of: the request signal reception unit 102 for receiving a process authorization request signal sent from the requester terminal 110 that requests for the information delivery between the terminals; the relevant information transmission request unit 105c for requesting the request reception terminal 120 to responds with the information at a designated location of the requested file information; the relevant information extraction unit 1101 for extracting and holding a part out of the data that is to be delivered between the terminal apparatuses; and the relevant information comparison unit 105e for comparing the extracted file information stored in the database to the relevant file information included in the response packet 620 sent from the request reception terminal 120 and for verifying the validity of the file information that is to be delivered between the terminals.

The requester terminal 110 of the first embodiment is composed of: the request signal issuing unit 113 for issuing an authorization request signal to the management apparatus 100; and the process command generation unit 114a for generating the process command to perform the processing with the other terminal apparatus when the granting signal is received from the management apparatus 100.

The request reception terminal 120 is composed of: the relevant information readout unit 124a for reading out the relevant information from the delivery object file that is notified from the management apparatus 100 as well as generating the response packet 620; and the process command generation unit 124b for receiving the delivery granting signal from the management apparatus 100 and generating the process command to perform the processing with the other terminal apparatus.

For the delivery of file information between the terminals, the requester terminal 110 first sends the process authorization request signal to the management apparatus 100 which in turn directs the relevant information comparison unit 105e to verify the validity of the delivery object file information, so that the authorized data delivery can be performed between the terminals only after the management apparatus 100 sends the delivery granting information to the requester terminal 110 and the request reception terminal 120. Thus, unauthorized file information delivery between the terminals can be prevented, and the management system is accordingly realized with ensured safety.

Moreover, for the management of file information that is to be delivered between the terminals, the management apparatus 100 does not manage the whole of delivery object file but extracts at least a part of the file information for the verification processing. As a result, the process load of the management apparatus 100 can be reliably reduced, and the management apparatus 100 can be saved from having to store and manage all of the contents the way a conventional server apparatus has to. Also, because the management apparatus 100 always verifies the validity of file information that is to be delivered, no area needs to be provided specifically for the data verification in the terminal apparatuses. Therefore, resources and load of the requester terminal 110 and the request reception terminal 120 are reduced, resulting in the increase of the network reliability.

Regarding the delivery of file information between the management apparatus 100 and the terminals, not the entity of file information but only the authorization signals are exchanged. Thus, the delivery and management of mass files are unnecessary. Consequently, processing performed by the management apparatus 100 is significantly lightened and file information can be safely delivered between the terminals.

Furthermore, by registering the file information to the management apparatus 100, the request reception unit 120 can achieve the delivery of safe file information with the other terminal apparatus via the network. As a result, unauthorized duplication is prevented, and users can safely perform the file exchange.

The management apparatus 100 registers the name for each set of processing information to the database so as not to process file information that has not been pre-registered under authorization. This feature enhances the safety of the network employed between the terminals.

The management apparatus 100 also registers the contents of the processing information which will be used for the verification, thereby increasing the validity of the processing information.

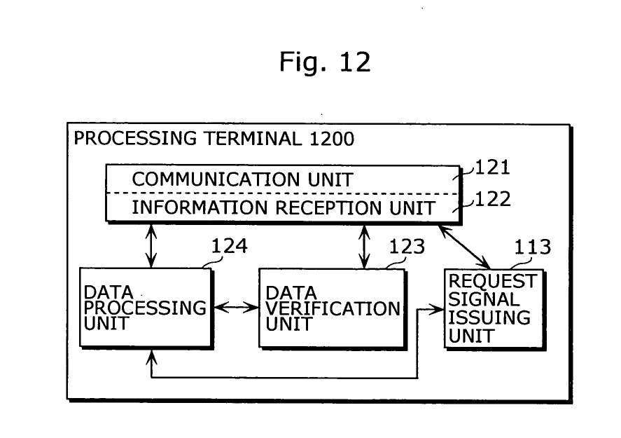

Note that, as shown in FIG. 12, the processing terminal 1200 can be provided with both a request signal issuing unit 113 for issuing an authorization request signal and a data verification unit 123 for responding with the relevant information.

With both the request sending and receiving functions, when receiving a delivery of file information from a terminal apparatus such as a requester terminal that also serves as a contents holder, the processing terminal 1200, in turn, functions as a request reception terminal and can deliver the previously-received file information to a requester terminal under the authorization of the management apparatus 100.

In the first embodiment, after the delivery authorization is granted, it is the requester terminal 110 that accesses to the request reception unit 120 to perform the delivery processing. However, the management apparatus 100 may multiplex the information of the requester terminal 110 into the granting information that is to be sent to the request reception unit 120, so that the delivery processing to deliver the file information may be started by the request reception terminal 120.

The management apparatus 100 of the present invention can also receive a delivery request from the request reception terminal 120 that has file information such as contents file and wishes to deliver the file information. In this case, the file information, whose validity has been verified, can be delivered to the other terminal apparatus via the management apparatus 100. Accordingly, the management system of the present invention is effective in a case where a terminal apparatus serving as a contents file generator requests to deliver its own generated contents file.

### Second Embodiment

The following is a description of the second embodiment of the present invention.

The management apparatus 100 of the second embodiment is characterized by a data registration unit 1301 that is provided to store at least a part of file information uploaded from the request reception unit 120. Note that for the components in the management apparatus 100, the requester terminal 110, and the request reception terminal 120 that have the respective same constructions as in the first embodiment, the same numerals are assigned and no detailed explanation is given.

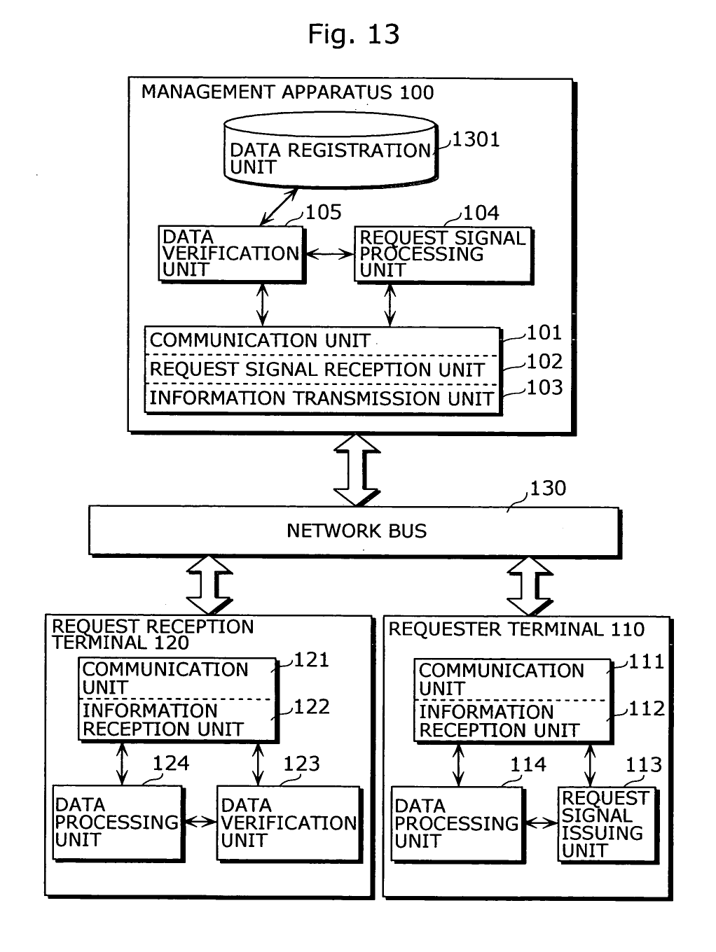

FIG. 13 is a functional block diagram of the management system that is composed of the management apparatus 100, the requester terminal 110, and the request reception terminal 120 in the second embodiment. In the second embodiment, the management apparatus 100 is provided with the data registration unit 1301.

The data registration unit 1301 stores a part of file information uploaded from the request reception terminal 120. The management apparatus 100 performs the verification processing on the file information held by the request reception terminal 120 as long as the file information is pre-registered in the data registration unit 1301. The data registration unit 1301 registers not only the file name but also data itself, thereby increasing the precision in the data verification performed by the management apparatus 100.

Next, an operational procedure performed by the management apparatus 100 of the second embodiment is explained.

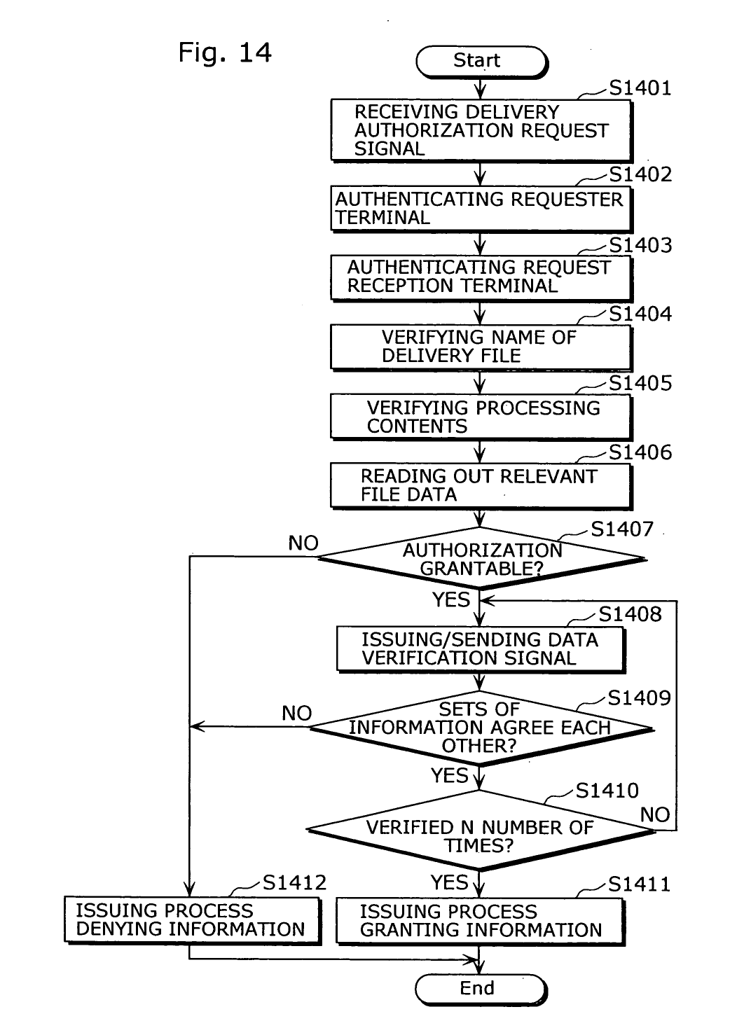

FIG. 14 is a flowchart showing the operational procedure from the reception of an authorization request signal to the issue of the granting information by the management apparatus 100. Note that this procedure in the second embodiment is characterized by that the management apparatus 100 judges whether the file information read out from the delivery authorization request signal is pre-registered in the data registration unit 1301 (S1407).

First, the request signal reception unit 102 of the management apparatus 100 receives the process authorization request signal from the requester terminal 110 (S1401). Then, the request signal processing unit 104 authenticates the requester terminal 110 based on the user ID 603 included in the process authorization request signal 600 (S1402). The request signal processing unit 104 next obtains the request reception terminal 120, that has the requested file information, from the destination ID 604 and authenticates it (S1403). The request signal processing unit 104 then interprets the contents of the process authorization request signal by reading out the processing object file number 605 and the processing type number 606 (S1404 and S1405).

Following this, the request signal processing unit 104 reads out the relevant file data (S1406), and the management apparatus 100 of the second embodiment performs the verification processing to check if the file name read out from the deliver authorization request signal is present in the data registration unit 1301 as the pre-registered file information (S1407). By this verification processing, if the file is not pre-registered in the data registration unit 1301 (NO in S1407), the authorization cannot be granted and delivery denying signal is issued to the request reception terminal 120 (S1412).

Meanwhile, if it is the file information pre-registered in the data registration unit 1301 (YES in S1407), the relevant information confirmation unit 105a confirms the relevant file as well as the request reception terminal 120 that has the relevant file, based on the process authorization request signal. The relevant information readout unit 105b reads out the information relevant to the file confirmed by the relevant information confirmation unit 105a, from the data registration unit 1301.

For the data verification, the relevant information transmission request unit 105c generates the relevant information response request signal 610 and sends it to the request reception terminal 120 that has the relevant file (S1408). Next, the relevant information reception unit 105d performs processing to receive the relevant information response from the request reception terminal 120 (S1409). When receiving the relevant information, the relevant information reception unit 105d sends it to the relevant information comparison unit 105e. The relevant information comparison unit 105e compares the relevant information sent from the request reception terminal 120 to the relevant information read out by the relevant information readout unit 105b from the data registration unit 1301. If these sets of information are in agreement with each other and the received information is judged to be valid (YES in S1409), the relevant information comparison unit 105e judges whether this comparison processing should be performed N number of times at several locations of data for the verification (S1410).

After completing the judgment processing N number of times (YES in S1410), the relevant information comparison unit 105e sends the process granting signal to the information transmission unit 103. On the other hand, if judging that the information is not valid (NO in S1409), the relevant information comparison unit 105e sends a process denying signal to the information transmission unit 103.

The information transmission unit 103 sends the process granting information or process denying information sent from the request signal processing unit 104 or the data verification unit 105 to the requester terminal 110 and the request reception terminal 120 via the communication unit 101 (S1411 and S1412).

Note that terminal information may be registered together with the data into the data registration unit 1301, and that authorization conditions may be set for each terminal in the step of granting authorization (S1407).

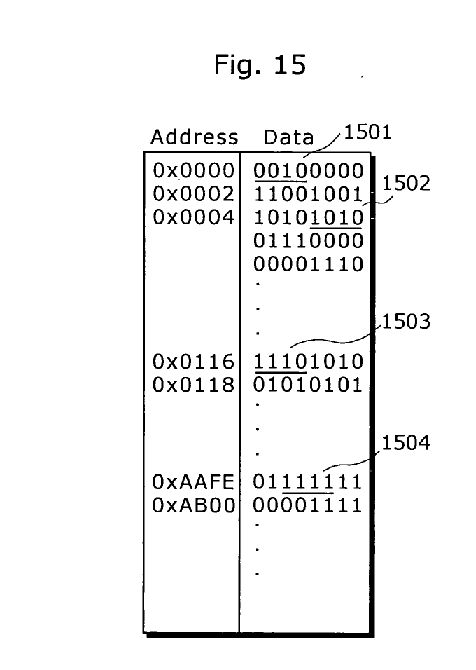

FIG. 15 a reference diagram of data stored in the data registration unit 1301.

First, as the method for verifying the validity of data to be delivered between the terminals, the data verification unit 105 designates an address of the delivery object file so that the data verification unit 123 of the request reception terminal 120 responds with a value at the designated address as a response.

For example, when the relevant information transmission request unit 105c of the management apparatus 100 sends a response request to the request reception terminal 120 to respond with a value at the address “0x0000”, the relevant information readout unit 124a reads out the data at this designated address and responds with the read value to the management apparatus 100.

The relevant information comparison unit 105e compares the responded value to the value “0010 (indicated by 1501)” registered in the data registration unit 1301. If the values are verified to be in agreement with each other, the relevant information transmission request unit 105c further requests the request reception terminal 120 to respond with respective values at the addresses “0x0004”, “0x0116”, and “0xAAFE”. If the values transmitted from the terminal 120 are verified to be in agreement respectively with “1010 (indicated by 1502)”, “1110 (indicated by 1503)”, and “0111 (indicated by 1504)”, the data file to be delivered between the terminals is judged to be valid.

Note that the data registration unit 1301 does not need to register the whole of file information for the verification performed by the data verification unit 105 of the management apparatus 100, and that arbitrary addresses and corresponding values that are supposed to be described at these addresses may be stored in pairs for the data validity verification. Consequently, a memory resource can be saved and, at the same time, the same effect can be obtained as with the case where the whole of file information is registered. Also, by changing the designated addresses for each terminal and each access time even if the same file is requested, the management apparatus 100 can ensure the higher validity of file information.

As the method employed by the relevant information comparison unit 105e for the verification of the validity regarding the delivery object file information, the request reception terminal 120 may be requested to transmit an address at which a designated data pattern is multiplexed, or the number of the designated data patterns that are multiplexed in the file.

Moreover, the management apparatus 100 may store a processing history and vary the data verification method depending on the stored processing history. For example, if a terminal apparatus has performed valid processing over several tens of times in a row, the management apparatus 100 may lighten and simplify the verification processing for this terminal apparatus. Meanwhile, if another terminal apparatus performed invalid processing in the past, the management apparatus 100 may increase the number of times and types of the verification processing for this terminal apparatus. Accordingly, processing efficiency in the file delivery executed between the terminals can be increased, and safety can be ensured as well.

In the management system of the second embodiment as described above, the management apparatus 100 includes the data registration unit 1301 for registering and managing the file information that is to be delivered between the terminals.

Thus, the delivery authorization can be granted only to the file information that is pre-registered in the data registration unit 1301, and unauthorized file delivery on the network can be prevented. Also, since at least a part of the file information that is to be delivered is registered into the data registration unit 1301, there is no need to manage the whole of mass file information such as a motion video file. Therefore, the data management can be performed by the management apparatus 100 with ease.

In order to increase the network security, the data format of the data registration unit 1301 of the second embodiment may be defined as an encrypted format, and a key to unlock encryption may be delivered only when the file information is validly delivered.

As an example method to check whether or not it is encrypted file information, the data registration unit 1301 may verify the 25^{th} and 26^{th} bits from the top, i.e., transport scrambling control bits multiplexed in the header of a transport stream packet when the format of a delivered file is a transport stream defined according to MPEG2 Systems standard.

As a matter of course, the level of security can be increased if the management apparatus 100 stores an encryption file to verify the file contents. The key to unlock the encryption may be given by the management apparatus 100, or alternatively, a key server may be provided for the key management.

### Third Embodiment

The following is a description of the third embodiment of the present invention. With a management system of the third embodiment, the requester terminal 110 does not send the delivery authorization request to the management apparatus 100, but sends the delivery request directly to the request reception terminal 120, and the data verification is performed between the management apparatus 100 and the request reception terminal 120.

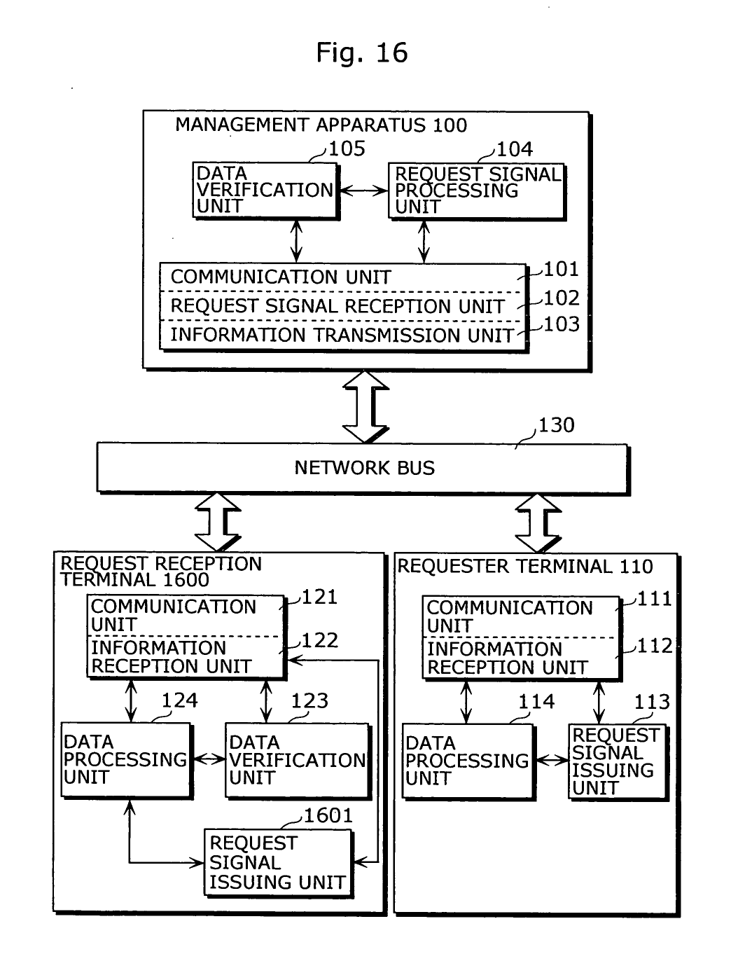

FIG. 16 is a block diagram showing the overall construction of the management system of the third embodiment.

The third embodiment is different from first embodiment in that a request reception terminal 1600 that receives a request is provided with a request signal issuing unit 1601.

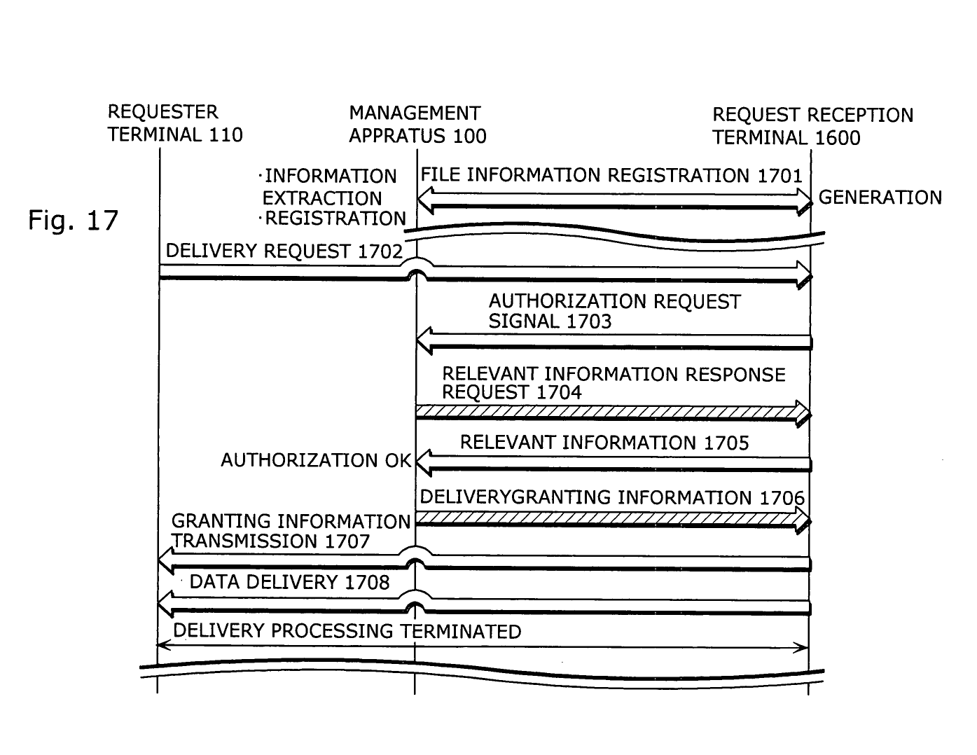

The operational procedure performed by the management system of the third embodiment is explained with reference to FIG. 17. FIG. 17 is a sequence diagram illustrating a general data flow in the management system of the third embodiment. Note that the management apparatus 100 previously acquires file information from the request reception terminal 1600, extracts at least a part of the file information, and registers the extracted part into the data registration unit 1301 (1701).

First, the request signal issuing unit 113 of the requester terminal 110 issues a process authorization request signal to the request reception terminal 1600 via the communication unit 111 (1702).

Then, receiving the process authorization request signal from the requester terminal 110, the request signal issuing unit 1601 sends a process authorization request signal (1703) to the management apparatus 100. Here, an ID number of the request reception terminal 1600 is multiplexed into the user ID included in the process authorization request signal.

The management apparatus 100 then sends a relevant information response request (1704) to the request reception terminal 1600 and, when receiving the relevant information (1705), the management apparatus 100 interprets the process authorization request signal. As distinct from the stated first and second embodiments, the ID of the request reception terminal 1600 is not multiplexed into the process authorization request signal and, therefore, the verification processing to authenticate the request reception terminal 1600 is omitted.

After completing the data verification processing, the management apparatus 100 sends a granting signal only to the request reception terminal 1600 (1706). If the information reception unit 122 receives the granting information, the request reception terminal 1600 sends the granting information (1707) to the requester terminal 110 via the communication unit 121. Consequently, processing such as delivery can be executed between the requester terminal 110 and the request reception terminal 1600.

Finally, the request reception terminal 1600 performs the data delivery of file information or the like for the requester terminal 110 (1708), where the sequential procedure of the third embodiment is terminated.

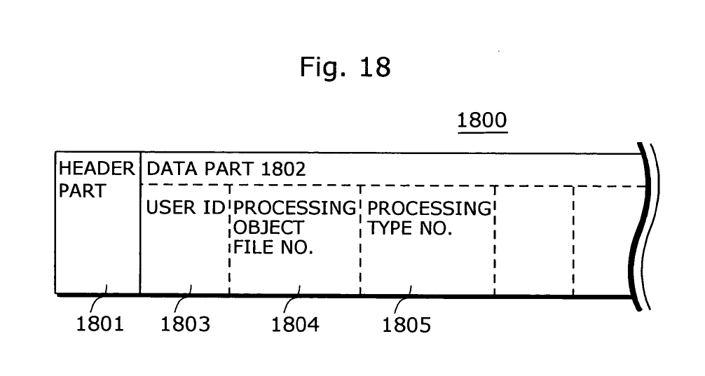

FIG. 18 shows an example data construction of a process authorization request signal 1800 issued to the request reception terminal 1600 by the requester terminal 110 in the third embodiment. This process authorization request signal 1800 is made up of: a header part 1801; and a data part 1802 including a user ID 1803, a processing object file number 1804, and a processing type number 1805. As distinct from the process authorization request signal 600 in the first embodiment, the destination user ID 604 is not included because the requester terminal 110 sends the request signal directly to the request reception terminal 1600.

With the stated construction of the management system of the third embodiment, the requester terminal 110 sends the process authorization request signal directly to the request reception terminal 1600 which, in turn, sends the file process request signal to the management apparatus 100. If the management apparatus 100 grants the delivery authorization, the request reception terminal 1600 sends the granting information to the requester terminal 110. Thus, the management system of the third embodiment can manage the validity of file information delivery performed between the terminals, as a system applicable to various communication forms.

### Fourth Embodiment

The following is a description of a management system of the fourth embodiment.

In recent years, remote diagnostics of home electrical appliances and remote maintenance to upgrade devices such as a DVD have been increasingly performed. However, a concern is rising with regard to the validity of data received through the remote maintenance. The fourth embodiment provides a management system by which remote maintenance data with a high degree of safety can be sent to a service object appliance of a user home.

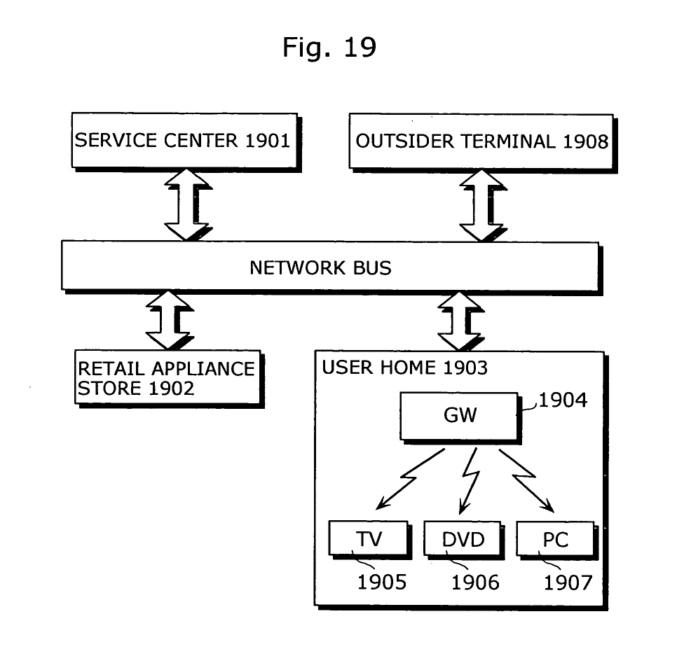

In the fourth embodiment, there are a requester terminal, a request reception terminal, and a separate appliance, with combination of which a network is formed. With reference to FIG. 19, an example is given for a case where the remote maintenance such as maintenance and repair is performed for a home electric appliance of the user home by a retail appliance store or the like using the network.

FIG. 19 shows the overall construction of the management system employed for the remote maintenance in the fourth embodiment.

A service center 1901 manages the validity of remote maintenance information. A retail appliance store 1902 sends the remote maintenance data to the electric appliance or the like of a user home 1903. The user home 1903 requests the retail appliance store 1902 for the maintenance of a TV set 1905, a DVD 1906, and a PC 1907 as well as receiving the remote maintenance data using a GW 1904.

The retail appliance store 1902 receives a request from its customer, i.e., the user home 1903, and then performs the remote maintenance for the appliance of the user home 1903. The retail appliance store 1902 first sends a process authorization request signal to the service center 1901. The service center 1901 verifies the validity of the remote maintenance data and, if the validity is verified, sends granting information to the retail appliance store 1902 so that the remote maintenance data is sent to a network-capable TV set of the user home 1903, for example.

In order to prevent a problem where a malicious outsider terminal 1908 requests the service center 1901 to perform only the authentication processing and then sends irrelevant virus data or the like, the user home 1903 may separately send a maintenance data verification request directly to the service center 1901 using the GW 1904 and implements the maintenance processing when the verification is received. By doing so, the remote maintenance system with a higher level of safety can be realized. Moreover, the remote maintenance data may be encrypted using a public key or the like of the service center 1901.

As can be understood from the above explanation, using the management system of the fourth embodiment, the remote maintenance data guaranteed as safe is sent to the user home 1903. Thus, the stated concern for the user home 1903 in the conventional remote maintenance is overcome, and a malicious outsider is absolutely prevented from conducting an unauthorized access that is “disguising” to deliver invalid maintenance data or the like.

Note that a register list of the terminals serving as file holders may be stored together with the file names and the file contents in the data registration unit 1301 of the management apparatus 100.

Every time a contents file is delivered from a terminal apparatus to the management apparatus 100, the file delivery source is added to the register list so as to update the list. As a result, the management apparatus 100 can always locate a file holder of the file information that is to be delivered between the terminals.

When the process authorization request signal is received from the requester terminal 110, the management apparatus 100 searches the register list for the terminal that holds the requested contents file, selects the appropriate requester reception terminal 120, and notifies the requester terminal 110 of the request reception terminal 120 as the search result.

When receiving the information regarding the requester terminal 120 by the communication unit 111, the requester terminal 110 performs the same processing as is the case in the third embodiment. Specifically, by sending the process authorization request signal to the request reception terminal 120 that is notified by the management apparatus 100, the requester terminal 110 can acquire the desired file delivery.

It should be noted here that after selecting the appropriate request reception terminal 120 from the register list according to the received process authorization request signal from the requester terminal 110, the management apparatus 100 may perform the data verification processing directly for the request reception terminal 120 that is the contents file holder, as is the case in the first embodiment.

Accordingly, since the management apparatus 100 searches the register list for the request reception terminal 120, the requester terminal 110 can safely acquire the desired file information from the request reception terminal 120 that is the contents holder without having to know the information regarding the request reception terminal 120. For the case of searching the register list for the request reception terminal 120, the destination user ID 604 does not need to be multiplexed into the process authorization request signal and can be left blank.

Also note that when verifying the file information that is to be delivered between the terminals, the management apparatus 100 may verify only information stored in a specific memory area of the request reception terminal 120. Thus, the verification processing object may be only the information stored in the specific memory area of the request reception terminal 120.

Moreover, the specific memory area (not shown) provided in the terminal apparatuses explained in the above-stated embodiment for storing processing object file can be made up of either a general memory unit or memory unit equipped with a security function such as access control, depending on to the expected level of reliability of the information. The specific memory area may be formed or designated by the user, or alternatively, may be generated using a program of the terminal apparatus.

Accordingly, when receiving the authorization request signal from the terminal apparatus that starts the processing, the management apparatus of the present invention performs the verification processing using at least a part of the data that is a processing object between the terminals. Therefore, the processing load of the data management and data verification can be lightened for the management apparatus side.

After performing the verification processing, the management apparatus sends a granting signal to the terminal apparatus when the validity is verified and sends a denying signal when the validity is not verified. Thus, the management system can be realized with the flexibility in the data processing performed between the terminals.

The requester terminal of the present invention only sends the delivery authorization request signal to the management apparatus, and the actual data verification is performed between the management apparatus and the request reception terminal. Therefore, the requester terminal can acquire the validity-verified data from the request reception terminal under no heavy load.

Also, because the validity of processing object data is always verified by the management apparatus, no area needs to be provided specifically for the data verification in the terminal apparatuses. Thus, resources and load of the terminal apparatuses are reduced, resulting in the increase in reliability of the data exchange between the terminals via the network.

Moreover, the management apparatus stores the file name and at least a part of the file information that is to be exchanged between the terminals, and rejects the processing of file information that is not pre-registered under authorization. By doing so, the reliability of the data exchange between the terminals via the is network can be increased.

Furthermore, since the management apparatus verifies whether or not the data delivery, movement, etc. is to be authorized, the data processing history of the terminals can be managed and controlled. Thus, the reliability of data exchange between the terminals via the network can be increased.

What is claimed is:

1. A management apparatus which is connected to terminal apparatuses via a network and manages data processing performed between the terminal apparatuses, comprising:
a reception unit operable to receive a request signal from one of the terminal apparatuses that requests for the data processing; and
a verification unit operable to verify validity of data relevant to the data processing when receiving the request signal.

2. The management apparatus according to claim 1,
wherein the verification unit verifies the validity of the data using at least a part of information of the data, and
wherein the management apparatus further comprises:
an issuing unit operable to issue a granting signal to the terminal apparatus when the validity of the data is verified by the verification unit, and issue a denying signal to one of the terminal apparatus that performs the data processing and another terminal apparatus that is requested to perform the data processing or both the terminal apparatus and the other terminal apparatus when the validity of the data is not verified by the verification unit; and
a transmission unit operable to transmit one of the granting and denying signals to the terminal apparatus.

3. The management apparatus according to claim 2 further comprising:
a download unit operable to download the data, which is to be processed between the terminal apparatuses, from the terminal apparatus;
an extraction unit operable to extract at least a part of information for each set of the downloaded data;
a storage unit operable to store the information extracted by the extraction unit; and
a response requesting unit operable to send a response request to a request reception terminal, which is requested to perform the data processing, for a response with information relevant to first information stored in the storage unit,
wherein the verification unit verifies the validity of the data by comparing the first information to second information sent from the request reception terminal apparatus responding to the response request.

4. The management apparatus according to claim 3,
wherein the first information is one of a value at a specific location of the data and an indication whether a flag is set.

5. The management apparatus according to claim 3,
wherein the first information is one of a location where a specific file pattern is described on the data and the number of specific file patterns on the data.

6. The management apparatus according to claim 3,
wherein the first information is one of a header part of the data and a format part at a specific location of the data.

7. The management apparatus according to claim 3,
wherein the storage unit is capable of storing only the data that is encrypted.

8. The management apparatus according to claim 3,
wherein the verification unit verifies whether the data is pre-registered in the storage unit,
wherein the issuing unit issues the granting signal to the terminal apparatus when the data is pre-registered in the storage unit.

9. The management apparatus according to claim 1,
wherein the request signal includes information regarding at least one of the terminal apparatus that request for the data processing, a request reception terminal that is requested to perform the data processing, an ID number of the data, and a data processing type,
wherein the management apparatus further comprises:
a signal processing unit operable to process contents of the request signal; and
a locating unit operable to locate the request reception terminal apparatus that is requested to perform the data processing, by reference to the request signal.

10. The management apparatus according to claim 9,
wherein the storage unit holds a register list in which terminal apparatuses having data that is to be processed,
wherein the locating unit locates the request reception terminal by reference to the register list.

11. The management apparatus according to claim 10 further comprising
a list updation unit operable to update the register list.

12. The management apparatus according to claim 1 further comprising:
a history hold unit operable to hold a processing history; and
a process judgment unit operable to make a judgment regarding the data processing that is to be performed between the terminal apparatuses, based on the processing history,
wherein the verification unit verifies the validity of the data, based on the judgment made by the process judgment unit.

13. The management apparatus according to claim 1,
wherein the data processing type between the terminal apparatuses is one of delivery, movement, and deletion.

14. A terminal apparatus that is connected to a management apparatus via a network and performs data processing with another terminal apparatus, the management apparatus managing the data processing performed between the terminal apparatus and the other terminal apparatus, the terminal apparatus comprising:
a reception unit operable to receive a request for the data processing;
a second issuing unit operable to issue a request signal requesting for the data processing; and
a second transmission unit operable to transmit the request signal to the management apparatus.

15. The terminal apparatus according to claim 14 further comprising:
a second storage unit operable to store data relevant to the data processing;
a readout unit operable to read out, when a response request for a response with information regarding at least a part of the data is received from the management apparatus, relevant information relevant to the response request from the second storage unit; and
a response unit operable to respond to the management apparatus with the relevant information read out by the readout unit.

16 The terminal apparatus according to claim 15,
wherein the relevant information is one of:
a value at a specific location of the data;
an indication of whether a flag is set;
a location where a specific file pattern is described on the data;
the number of specific file patterns on the data;
a header part of the data; and
a format part of the data.

17. The terminal apparatus according to claim 14 further comprising:
a second reception unit operable to receive one of granting and denying signals from the management apparatus, the signals respectively indicating that the data processing to be performed with the other terminal apparatus is authorized and unauthorized;
a judgment unit operable to judge that the data processing performed with a request reception apparatus, that is requested to perform the data processing, is to be started when the granting signal is received, and judge that the data processing performed with the request reception terminal is not to be performed when the denying signal is received; and
a data processing unit operable to perform the data processing with the other terminal apparatus in accordance with details authorized by the management apparatus when the granting signal is received.

18. The terminal apparatus according to claim 17 further comprising
a generation unit operable to generate granting information indicating that the data processing is authorized to be performed, when the granting signal is received,
wherein the second transmission unit transmits the granting information to a terminal apparatus that requests the data processing.

19. The terminal apparatus according to claim 14 further comprising
an upload unit operable to upload the data that is to be processed between the terminal apparatuses to the management apparatus.

20. The terminal apparatus according to claim 14,
wherein when the second reception unit receives the request signal from the other terminal apparatus, the second issuing unit issues a request signal anew and the second transmission unit sends the request signal issued by the second issuing unit to the management apparatus.

21. The terminal apparatus according to claim 14,
wherein the terminal apparatus holds data processible with the other terminal apparatus, further comprising
a delivery requesting unit operable to generate a delivery request to deliver the data to the other terminal apparatus, and send the delivery request to the management apparatus.

22. The terminal apparatus according to claim 14,
wherein the data processing type between the terminal apparatuses is one of delivery, movement, and deletion.

23. A management system comprising a management apparatus and a plurality of terminal apparatuses which are all connected via a network,
wherein the management apparatus manages data processing performed between the terminal apparatuses and includes:
a reception unit operable to receive a request signal from a requester terminal that requests for the data processing to be performed by a request reception terminal; and
a verification unit operable to verify validity of data relevant to the data processing when the request signal is received,
wherein each terminal apparatus includes:
a reception unit operable to receive a request for the data processing;
a second issuing unit operable to issue a request signal requesting for the data processing; and
a second transmission unit operable to transmit the request signal to the management apparatus,
wherein only the data that has been verified by the verification unit is capable of being processed between the terminal apparatuses.

24. The management system according to claim 23,
wherein the management apparatus further includes:
a download unit operable to download the data, which is to be processed between the terminal apparatuses, from the terminal apparatus;
an extraction unit operable to extract at least a part of information for each set of the downloaded data;
a storage unit operable to store the information extracted by the extraction unit; and
a response requesting unit operable to send a response request to a request reception terminal, which is requested to perform the data processing, for a response with information relevant to first information stored in the storage unit,
wherein each terminal apparatus further includes:
a second storage unit operable to store the data;
a readout unit operable to read out, when the response request is received from the management apparatus, second information relevant to the response request out of the data stored in the second storage unit; and
a response unit operable to respond to the management apparatus with the second information read out by the readout unit,
wherein the verification unit verifies the validity of the data by comparing the first information to the second information sent from the response unit.

25. The management system according to claim 24,
wherein each of the first information and the second information is one of:
a value at a specific location of the data;
an indication of whether a flag is set;
a location where a specific file pattern is described on the data;
the number of specific file patterns on the data;
a header part of the data; and
a format part of the data.

26. The management system according to claim 23,
wherein the management apparatus further includes:
an issuing unit operable to issue a granting signal to the terminal apparatus when the validity of the data is verified by the verification unit, and issue a denying signal to one of the terminal apparatus that performs the data processing and another terminal apparatus that is requested to perform the data processing or both the terminal apparatus and the other terminal apparatus when the validity of the data is not verified by the verification unit; and
a transmission unit operable to transmit one of the granting and denying signals to the terminal apparatus,
wherein each terminal apparatus further includes:
a second reception unit operable to receive one of granting and denying signals from the management apparatus;
a judgment unit operable to judge that the data processing performed with a request reception apparatus, that is requested to perform the data processing, is to be started when the granting signal is received, and judge that the data processing performed with the request reception terminal is not to be performed when the denying signal is received; and
a data processing unit operable to perform the data processing with the other terminal apparatus in accordance with details authorized by the management apparatus when the granting signal is received.

27. The management system according to claim 23,
wherein the data is remote maintenance data that is used by the management apparatus for a repair made on a terminal appliance in a user home via the network.

28. A management method for managing data processing performed between terminal apparatuses via a network, the management method comprising:
a reception step of receiving a request signal from one of the terminal apparatuses that requests for the data processing; and
a verification step of verifying validity of data relevant to the data processing when receiving the request signal.

29. The management method according to claim 28,
wherein the validity of the data is verified using at least a part of information of the data in the verification step, and
wherein the management method further comprises:
an issuing step of issuing a granting signal to the terminal apparatus when the validity of the data is verified by the verification unit, and issuing a denying signal to one of the terminal apparatus and another terminal apparatus that is requested to perform the data processing or both the terminal apparatus and the other terminal apparatus when the validity of the data is not verified by the verification unit; and
a transmission step of transmitting one of the granting and denying signals to the terminal apparatus.

30. The management method according to claim 28 further comprising:
a download step of downloading the data, which is to be processed between the terminal apparatuses, from the terminal apparatus;
an extraction step of extracting at least a part of information for each set of the downloaded data;
a storage step of storing the information extracted by the extraction unit; and
a response requesting step of sending a response request to a request reception terminal, which is requested to perform the data processing, for a response with information relevant to first information stored in the storage unit,
wherein the validity of the data is verified by comparing the first information to second information sent from the request reception terminal apparatus responding to the response request in the verification step.

31. A program for a management apparatus that manages data processing performed between terminal apparatuses,
the program causing a computer and a portable remote terminal to execute all of the units provided in the management apparatus described in one of claims 1 to 13.

32. A program for a terminal apparatus that performs data processing with another terminal apparatus,
the program causing a computer and a portable remote terminal to execute all of the units provided in the terminal apparatus described in one of claims 14 to 22.
